(19) United States
(12) Patent Application Publication
(10) Pub. No.: US 2015/0235265 A1
(43) Pub. Date: Aug. 20, 2015

(54) Network Neighborhood Marketing and Participant System

(71) Applicants: Michael J. Lefevre, Laguna Niguel, CA (US); Sheli L. Jones, Huntington Beach, CA (US)

(72) Inventors: Michael J. Lefevre, Laguna Niguel, CA (US); Sheli L. Jones, Huntington Beach, CA (US)

(21) Appl. No.: 14/623,154

(22) Filed: Feb. 16, 2015

Related U.S. Application Data
(60) Provisional application No. 61/940,573, filed on Feb. 17, 2014.

(51) Int. Cl. G06Q 30/02; G06Q 50/00

(52) U.S. Cl. CPC G06Q 30/0258; G06Q 30/0261; G06Q 50/01

(57) ABSTRACT

Disclosed embodiments include a marketing opportunity and participant verification system wherein a “Neighborhood Specialist” is designated as a central point of contact for registered neighborhood residents. System owners may lease the position of Neighborhood Specialist to any type of vendor, such as a real estate agent. A Neighborhood Specialist may then acquire registered neighborhood residents by various means, include the distribution of individualized invitations the invitations having unique serial numbers or other identifying information. Once a prospective neighborhood resident is verified by the Neighborhood Specialist, the newly registered neighborhood resident may post electronic messages for the exclusive preview of the Neighborhood Specialist. After the preview and possible response by the Neighborhood Specialist, the message is posted to the other registered neighborhood residents. The Neighborhood Specialist enjoys unique and personalized contact with residents of a specific neighborhood, providing quality marketing opportunities.

### CROSS-REFERENCE TO RELATED APPLICATIONS

This utility application is based upon U.S. Patent Application 61/940,573 filed on Feb. 17, 2014. This related application is incorporated herein by reference and made a part of this application. If any conflict arises between the disclosure of the invention in this utility application and that in the related provisional application, the disclosure in this utility application shall govern. Moreover, the inventor(s) incorporate herein by reference any and all patents, patent applications, and other documents hard copy or electronic, cited or referred to in this application.

### COPYRIGHT AND TRADEMARK NOTICE

This application includes material which is subject or may be subject to copyright and/or trademark protection. The copyright and trademark owner(s) has no objection to the facsimile reproduction by any of the patent disclosure, as it appears in the Patent and Trademark Office files or records, but otherwise reserves all copyright and trademark rights whatsoever. Terms subject to copyright and/or trademark protection may include “Network Neighborhood™” “Neighboorhood Specialist™”, “NeighborhoodLane™” and “Bringing America Home™”.

### (1) FIELD OF THE INVENTION

The invention generally relates to electronic marketing systems. More particularly, the invention relates to means and methods of geo-specific marketing systems with primary communication rights leased or licensed to a single individual or organization.

### (2) DESCRIPTION OF THE RELATED ART

In the related art, the following systems or patent documents are known:

LinkedIn, Nextdoor, U.S. Pat. No. 6,480,885 by Olivier, U.S. Pat. No. 7,092,821 by Mizrahi et al, U.S. Pat. No. 8,359,544 by Dolin et al, U.S. Pat. No. 8,548,423 by Rao, U.S. Publication 2007/0218900 by Abhyanker, U.S. Publication 2009/0228305 by Gustafsson et al, U.S. Publication 1010/0056138 by Oh, U.S. Publication 2011/0275441 by Wilson, and U.S. Publication 2013/0316751 by Rao.

But, the known related art fails to teach, disclose or suggest the use of a person or organization to act as a communication conduit or Neighborhood Specialist™ to accept marketing opportunities within a predefined geographic location or neighborhood. Thus, for this reason and others disclosed below, there is room in the art for the presently disclosed embodiments.

### BRIEF SUMMARY OF THE INVENTION

The present invention overcomes shortfalls in the related art by presenting an unobvious and unique combination and configuration of methods and components to create a neighborhood or geo specific communication system having a sole controller (sometimes known as a Neighborhood Specialist™) participant verification protocols, communication protocols, messaging systems and other attributes. Disclosed embodiments may be considered farming tools or unique and personalized marketing opportunities for real estate agents, brokers, realtors, loan brokers, merchants, service providers and others to engage in meaningful and sometimes personal communications with verified participants or consumers residing within a predefined area or neighborhood.

Owners or operators of the presently disclosed embodiments are presented with monetization opportunities by, inter alia, leasing or licensing exclusive communication control rights to a neighborhood leader, conduit or Neighborhood Specialist™. A neighborhood specialist or similarly titled individual or entity, individually reads, screens and if appropriate posts messages or other communications from verified participants.

Owners or operators of the disclosed embodiments may command premium lease or license rates from a neighborhood specialist as a neighborhood specialist will gain intimate knowledge and contact with the residents of their licensed neighborhood. The knowledge and close contact with verified participants gives neighborhood specialists unprecedented marketing leverage and competitive advantages since the neighborhood specialists have continuous and individualized contact with people located within a relevant geographic area.

For ground floor neighborhood specialists, the intimate relationship with people in a predefined neighborhood begins with the neighborhood specialist's role in verifying the identity and location of proposed participants. Upon initial contact with a proposed participant, a neighborhood specialist may engage in a personal meeting, telephone call or other communication to personally verify the claimed identity and residence of the proposed participant. The verification process leads to direct and substantive contact between a neighborhood specialist and a proposed participant. Upon verification, the proposed participant becomes a verified participant or registered neighborhood resident with means to communicate or convey messages, posts, photos, recipes, job listings and the like to the neighborhood specialist.

Upon receipt of a communication from a verified participant or registered neighborhood resident, the neighborhood specialist may send a personalized thank you note to the verified participant and then post or publish the communication as appropriate. The verified participants benefit by having access to hand filtered communications relevant to their neighborhood and by seeing the personal message amendments of the neighborhood specialist.

During the normal course of system enabled communications, the neighborhood specialist becomes familiar with the verified participants, who in turn are likely to hire the neighborhood specialist. In one contemplated embodiment, a neighborhood specialist may work as a real estate sales person and profit from real estate transactions conducted on behalf of verified participants and/or referrals from verified participants. Neighborhood specialists may be any type of vendor or hold any position.

Owners or operators of the disclosed embodiments are also presented with monetization opportunities by leasing or licensing a concierge service to vacationing neighborhood specialists.

Embodiments of the invention may also include the use of a marketing response strategy (MRS) which may comprise various computer implemented administrative tools and various protocols for artfully managing a mandatory reply post (MRP) or an optional reply post (ORP) as described below.

Disclosed embodiments may include various databases, processors, server systems, graphical user interfaces, non-volatile memory, machine readable instructions and the production of webpages and other electronic communications.

Disclosed embodiments overcome shortfalls in the art by providing a neighborhood specialist with many competitive advantages. For example, each neighborhood specialist has exclusive rights to a predefined geographic area that is populated with a plurality of verified participants. All messages from the verified participants residing within the predefined geographic area are routed exclusively to the neighborhood specialist of the predefined geographic area. Thus, every single post request is a unique marketing opportunity for the neighborhood specialist to respond to or otherwise manage. A verified participant's post could be something as simple as a recipe posting resulting in an opportunity wherein a neighborhood specialist can contact the verified participant and let them know that their post has been approved and that it is now posted. Such messaging may occur via an email, a personal phone call, text or other means.

A neighborhood specialist is enabled to contact the poster for reasons other than direct sales and specifically discuss the post. In the example above, the motivated neighborhood specialist will call a resident and complement them on what looks like a great recipe, ask if it is a family recipe or something they came up with themselves. The neighborhood specialist may follow up again to let the resident know that they tried the recipe and how much they liked it and that they plan on using it again. This allows for unique marketing opportunities by building relationships that become strong enough that for the professional services the neighborhood specialist becomes the first person a verified participant thinks of or refers to others.

Disclosed embodiments overcome shortfalls in the art by being an extremely powerful tool for building strong relationships as every system post is an opportunity to reach out in a positive manner and allow the neighborhood specialist to really get to know the residents on a personal level. If someone posts that they want to announce a birth of a child, a graduation, a job promotion and countless other situations then the neighborhood specialist can reach out and congratulation or provide other appropriate social responses. This interaction is intended to build relationships that are so strong that when a resident decides they need to utilize the services of the specialty of the neighborhood specialist they are the first person they will think and reach out, thereby generating revenue for the neighborhood specialist.

The value of the neighborhood specialist personally responding to opportunistic post (i.e., a lost pet post) is not only an effective and unique method of building real personal relationships with each and every resident in the neighborhood but also provides an exclusive and hyper competitive advantage for that neighborhood specialist in their chosen field.

The additional benefit of having a neighborhood specialist building relationships based off the unique marketing opportunities is that they can help facilitate a neighborhood to become a real community. They will help neighbors get to know other neighbors, learn about neighbors with special needs like the elderly that need a kind person to help them on occasion with projects that are hard for them to physically perform like getting the heavy trash cans out on trash day and put back when empty. The neighborhood specialist will use information gained from discussing the benefits of disclosed embodiments, sometimes referred to as “NeighborhoodLane™”, approving posts and sharing known news posted to those not yet signed up to help facilitate many activities. They can set up projects and ask for volunteers to help other neighbors, have community events like holiday decorating contests, block parties, and a host of other events that bring the community back together.

This will build community spirit and help with “Bringing America Home™” by getting back to the times when people who lived in neighborhoods knew each other, helped and supported one another and acted as a community rather than a cluster of individuals that are essentially strangers to one another.

Disclosed embodiments include a general or specialized computer system having a database or server system that accepts input from persons or organizations interested in purchasing or leasing a geographic area and becoming a neighborhood specialist.

Disclosed embodiments include a general or specialized computer system having a database or server system that accepts input and various system parameters to establish a neighborhood. Disclosed embodiments include is a first time set up or establishment process wherein a leasing neighborhood specialist may establish (within system defined restraints) settings or filters to view, capture, manage and respond to message posts from verified participants. A disclosed embodiment includes a general or specialized computer system having a database or server system to generate individual hand bills or fliers for each domicile within the specified geographic area. Each flier may be assigned a unique identifier code that maps to each domicile within the specified geographic area. The use of such unique codes increases system security to verify the claimed address of a person attempting to register with the system.

Disclosed embodiments include a general or specialized computer system having a database or server system that processes and if warranted, verifies and registers participants or neighbors living within the predefined geographic area. Disclosed systems include means of notifying a neighborhood specialist of every proposed post or message entered by a participant or neighbor. The neighborhood specialist becomes a first responder to every message from the neighborhood.

Disclosed embodiments overcome shortfalls in the art by requiring and/or enabling a neighborhood specialist to reply to or otherwise manage various posts from a neighbor within a predefined time period. Such posts are sometime labeled or called mandatory posts or mandatory replies. Disclosed mandatory reply systems overcome shortfalls in the art by encouraging quick contact with neighbors to further the neighborhood specialist to neighbor relationship. As neighborhood specialist approval is required before any verified participant or neighbor communication is posted publicly, a quick response protocol is needed to keep the message boards current and relevant. The preapproval system allows a neighborhood specialist to have a first response back to a neighbor to further solidify the neighborhood specialist's relationship and sales opportunities with the neighbors or verified participants. In contrast, a system “optional reply” or “optional reply post” may have a shorter time frame of response and may be managed by an auto response module of the system.

These and other objects and advantages will be made apparent when considering the following detailed specification when taken in conjunction with the drawings.

### BRIEF DESCRIPTION OF THE DRAWINGS

FIG. 1A is a flow chart of resident registration

FIG. 1B is a continuation of FIG. 1A

FIG. 2 depicts a flow chart of neighborhood specialist interest protocol

FIG. 3A depicts a flow chart regarding a neighborhood purchase or lease by a neighborhood specialist

FIG. 3B is a continuation of FIG. 3A

FIG. 4 depicts various reply settings

FIG. 5 depicts a resident posting interface

FIG. 6 depicts an initial solicitation to a potential verified participant

FIG. 7 depicts a pseudo screen shot of a NS administration page

FIG. 8 depicts a pseudo screen shot of both mandatory reply posts and optional reply posts

### REFERENCE NUMERALS AND ABBREVIATIONS IN THE DRAWINGS

NS or Neighborhood Specialist
100 resident registration process in general
110 a system generated unique registration code, may be applied to marketing materials.
120 resident login procedure
130 database of residents
140 screen for age or other criteria
140 a blocked or denied enrollment
150 agreement to system terms
155 decline of enrollment
160 verification and approval process
165 failure of verification or approval process
167 acceptance of verification and approval process
170 accepted or verified resident login
175 resident creation of messages
180 database of resident messages
200 neighborhood specialist (“NS”) interest process in general
210 NS interest form or process
220 selection of neighborhood
230 database of NS intake or master administration
240 communication of offer to lease a neighborhood or communication module
250 decision tree or module of purchase or lease
255 a negative decision to purchase or lease
260 path to lease or purchase process
270 completion of lease or purchase
300 NS purchase system in general
310 point of entry into a purchase system
320 entry of code or other identifier
330 decision or search for requested neighborhood
345 database of NS information and actions
350 decision to agree or disagree to system terms
355 a rejection to agree to system terms
360 completion of purchase form
370 receipt generated or module
380 acknowledgment message re permission to set up neighborhood
390 population of first time set up fields
392 master administrative database or neighborhood specialist intake database
395 start of NS operations
397 completion of NS entry
400 optional rely posting—auto response settings
410 notification settings for mandatory reply posts
500 a resident posting interface in general
510 an urgent posting option
520 a non-urgent posting option
600 a disclosed communication to a potential verified participant
610 registration key
700 a system alert to a NS regarding a mandatory reply post
710 a mapping of an alert to a mandatory reply posting
800 depiction of both mandatory and optional reply posts
810 depiction of mandatory reply posts 810
820 depiction of optional reply posts 820

### DETAILED DESCRIPTION OF EMBODIMENTS OF THE INVENTION

The following detailed description is directed to certain specific embodiments of the invention. However, the invention can be embodied in a multitude of different ways as defined and covered by the claims and their equivalents. In this description, reference is made to the drawings wherein like parts are designated with like numerals throughout.

Unless otherwise noted in this specification or in the claims, all of the terms used in the specification and the claims will have the meanings normally ascribed to these terms by workers in the art.

Unless the context clearly requires otherwise, throughout the description and the claims, the words “comprise,” “comprising” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “above,” “below,” and words of similar import, when used in this application, shall refer to this application as a whole and not to any particular portions of this application.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while steps are presented in a given order, alternative embodiments may perform routines having steps in a different order. The teachings of the invention provided herein can be applied to other systems, not only the systems described herein. The various embodiments described herein can be combined to provide further embodiments. These and other changes can be made to the invention in light of the detailed description.

Any and all the above references and U.S. patents and applications are incorporated herein by reference. Aspects of the invention can be modified, if necessary, to employ the systems, functions and concepts of the various patents and applications described above to provide yet further embodiments of the invention.

These and other changes can be made to the invention in light of the above detailed description. In general, the terms used in the following claims, should not be construed to limit the invention to the specific embodiments disclosed in the specification, unless the above detailed description explicitly defines

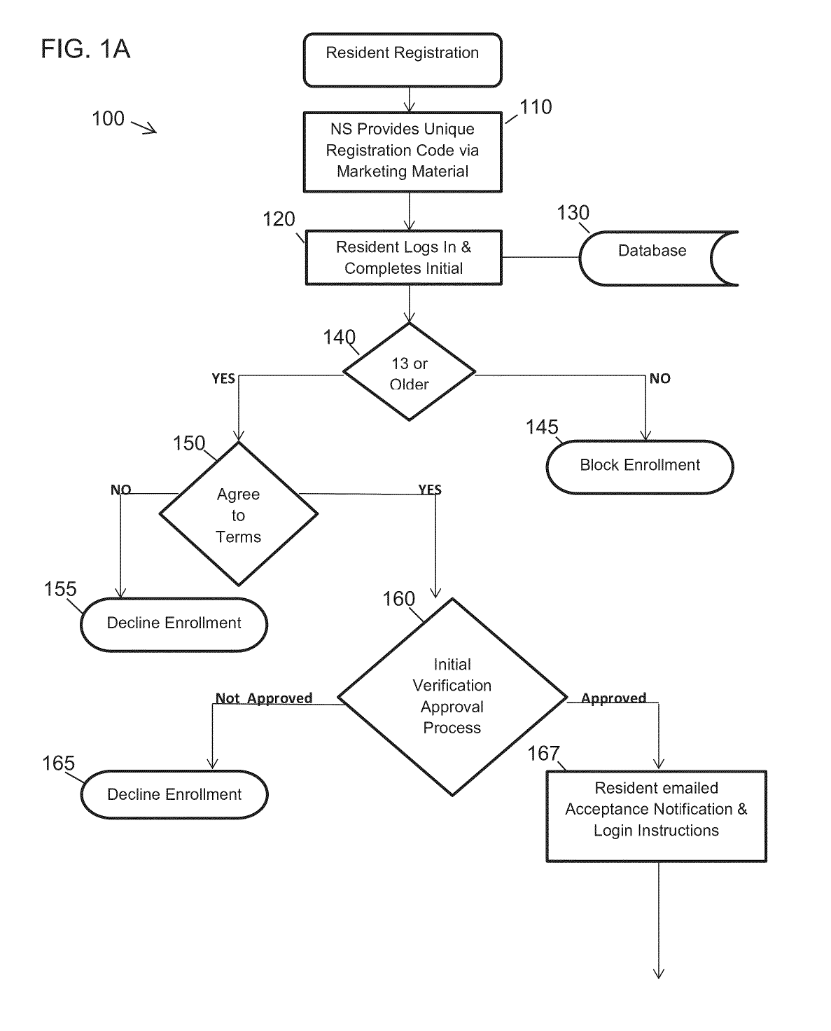

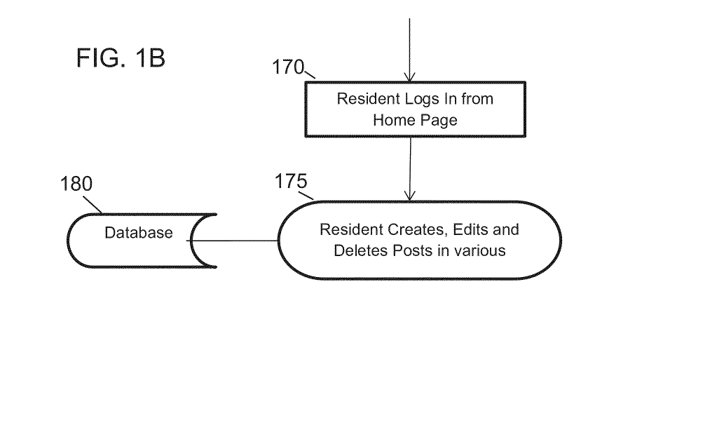

FIG. 1A and FIG. 1B depict a disclosed process of resident registration 100. A potential member, verified participant or neighbor may obtain a flier or handbill having a unique registration code generated 110 by the system. The potential member may login to the system via a web interface, phone app or other means and enter the unique registration code. The registration code is mapped in a database to the preselected address. A registration code may also be mapped to a relevant zip code or other geographic identifier. The potential resident competes a login or initial sign up process 120 with their information entered into a database of residents 130.

Various resident screening parameters 140 may be set, such as a minimum age. Enrollment may be blocked 145 due to a failure to meet system imposed qualifications. If system qualifications are met, system terms 150 may be declined 155, thus blocking enrollment. If agreement to system terms is obtained, an initial verification process 160 may commence. If address, zip code or other criteria are not verified, enrollment may be declined 165. If verification is successful, an acceptance notification process 167 may include an acceptance message and login instructions.

Referring to FIG. 1B, a resident may login from a resident home page and create posts 175, with such posts stored in a message database 180.

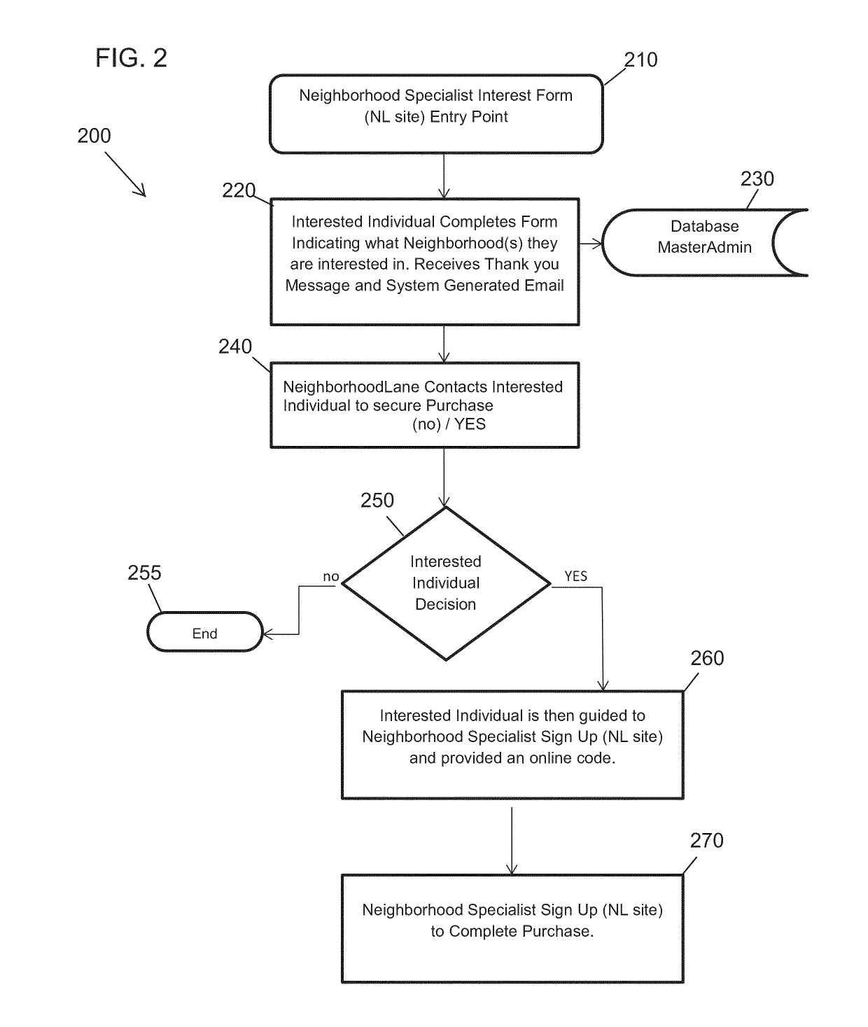

FIG. 2 depicts a general neighborhood specialist interest form process 200 which may comprise a form entry point 210 upon a web based system generated user interface. The system may accept information on what neighborhoods are of interest 220, with such entered information stored in a database 230 of NS intake or master administration. A communication module 240 may send a message to a potential NS regarding a proposed sale, lease or license of a neighborhood and the related NS rights.

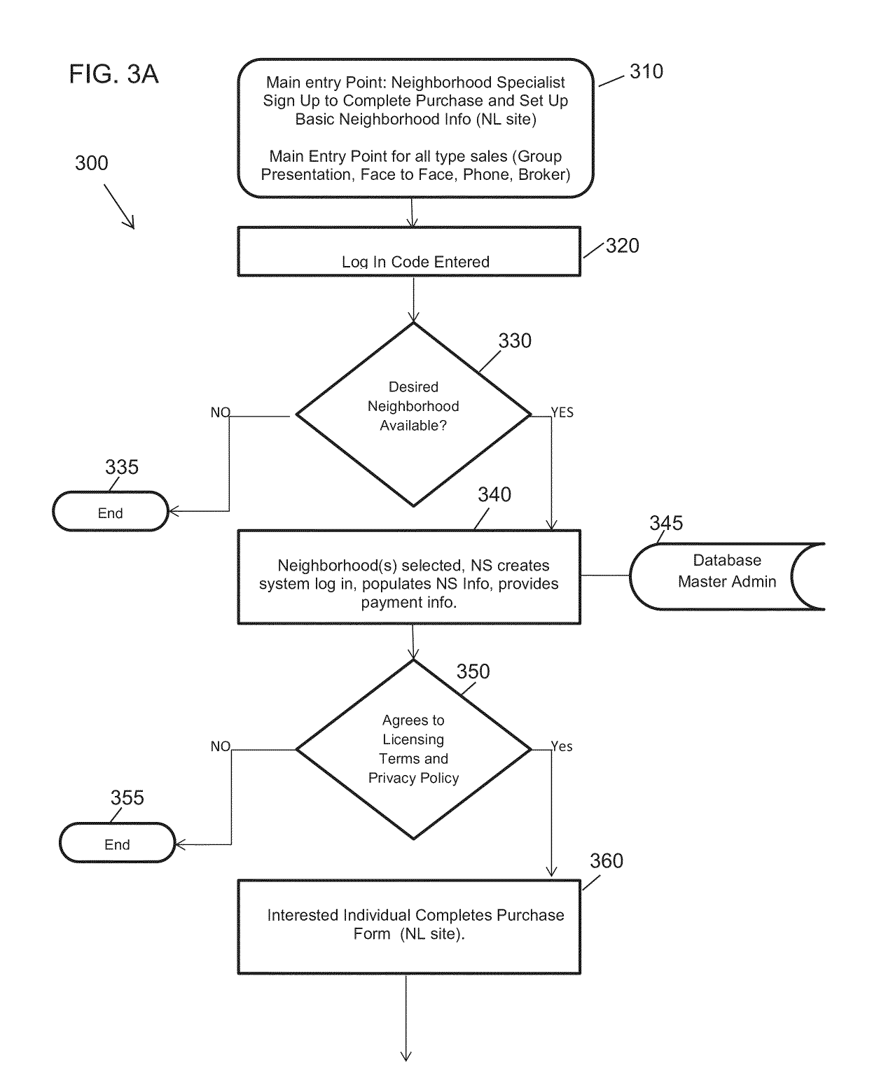

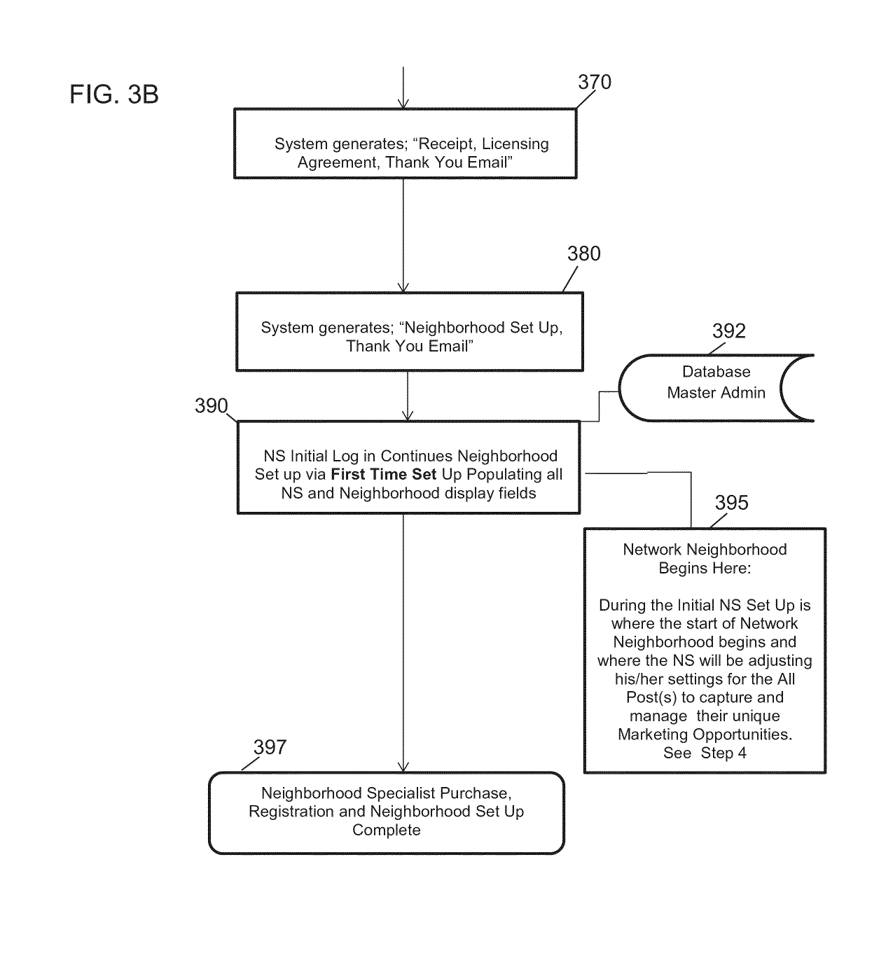

A decision tree 250 may result in the negative 255 or may result in positive with the potential NS directed to a sign up or purchase process, such as the one depicted in FIGS. 3A and 3B discussed below. Upon purchase completion 270, a NS begins setting up system parameters for their purchased neighborhood.

FIG. 3A depicts a general process 300 of a NS purchasing or leasing a neighborhood and related rights. A main entry point 310 may be presented in the form of a system generated interface. An interface 320 may accept a login code. A desired neighborhood may be searched 330 and if not available, the process ends 335. If a desired neighborhood is available, a login module 340 may create system login information for the ns and accept payment information. Such collected and generated information may be stored within a database 345 of NS information and actions.

A potential NS may be presented with system terms 350, if declined, the process stops 355, if accepted a purchase form 360 may be presented upon a system generated user interface.

FIG. 3B depicts a module 370 that may generate a receipt and/or lease or license agreement. A system generated set up message 380 may comprise further login information or login credentials to facilitate a first time set up process 390. A first time set up may require NS input or selections of various display fields. A NS starting module 395 may enable further adjustments of settings and the start of managing and transmitting user posts. Upon completion purchase and registration 387, a NS may begin to enjoy unique marketing opportunities and relationships within the leased neighborhood.

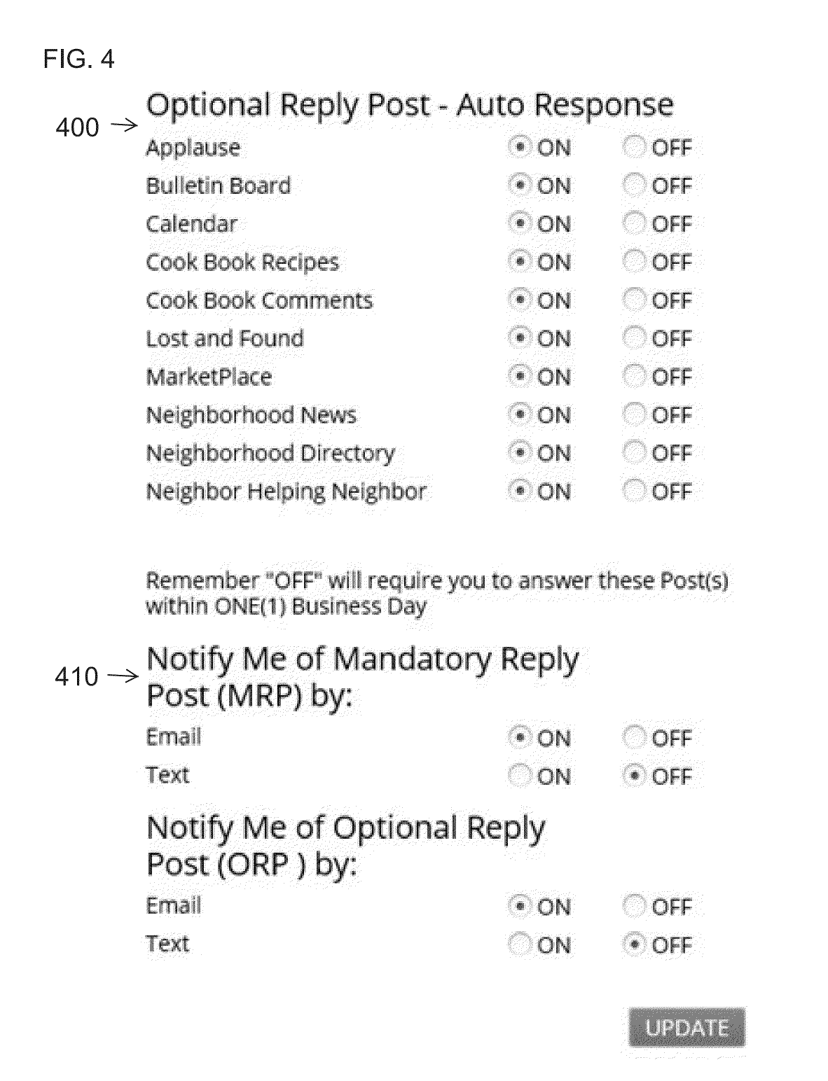

FIG. 4 depicts settings 400 for optional reply posts. Many post categories are “mandatory reply posts” and have various notification settings 410. Many post categories are in the “mandatory reply field” and require a NS to post a reply within a set time frame. A mandatory reply or mandatory post may require the personal attention of a NS, and may not be delegated to an auto reply function. An “optional reply post” may be managed by use of an auto response system, allowing the NS to conduct day-to-day business with fewer interruptions. Various categories within the optional reply post rubric may qualify for auto response management. In the example of FIG. 4 certain categories or message subjects may be considered non-urgent and thus qualify for auto response management. An auto response system or subsystem may include a dictionary of terms to omit before posting a message.

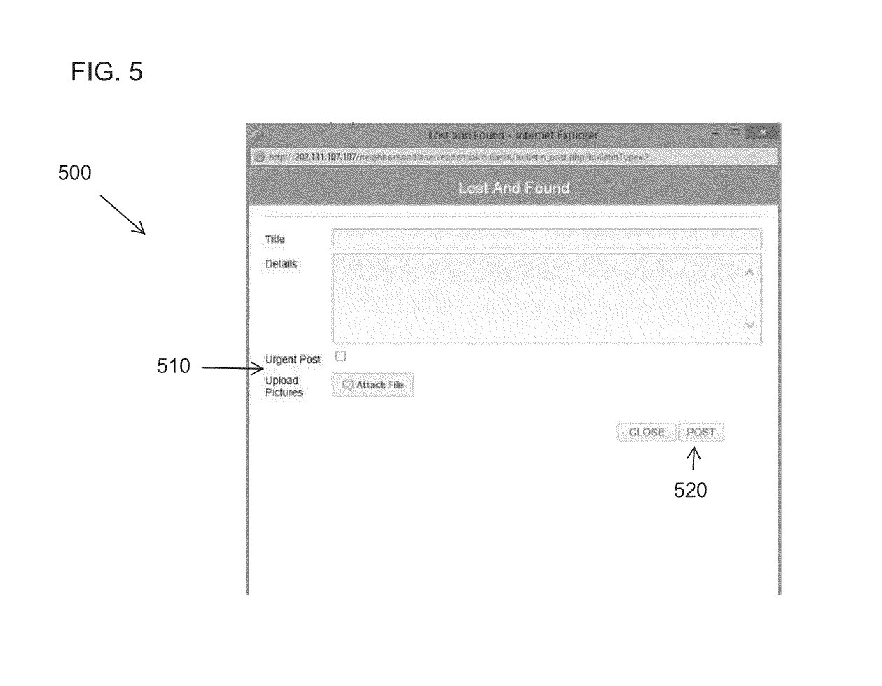

FIG. 5 depicts a pseudo screen shot of a Lost and Found Posting 500 interface that will allow an urgent post 510 designation or a normal post 520 designation. An urgent post triggers system parameters to require the NS to respond within a shorter predefined time frame. A normal post allows the NS a longer predefined time frame.

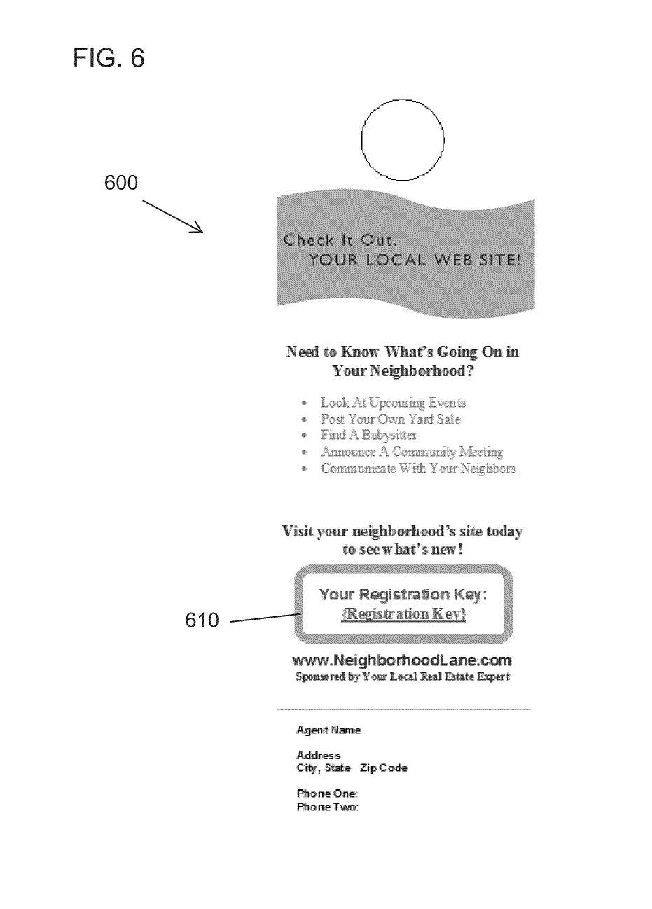

FIG. 6 depicts a disclosed initial communication 600 to a potential verified participant. The communication contains a unique registration key 610 which may be mapped to an address, zip code or other geo specific marker within the predefined geographic area or neighborhood. The potential verified participant may enter the registration key 610 upon system login along with a purported address. System databases may check the purported address with the system mapped address or zip code to look for a match. If the addresses and or zip code do not match, the NS may be notified and may offer personalized assistance to the potential verified participant.

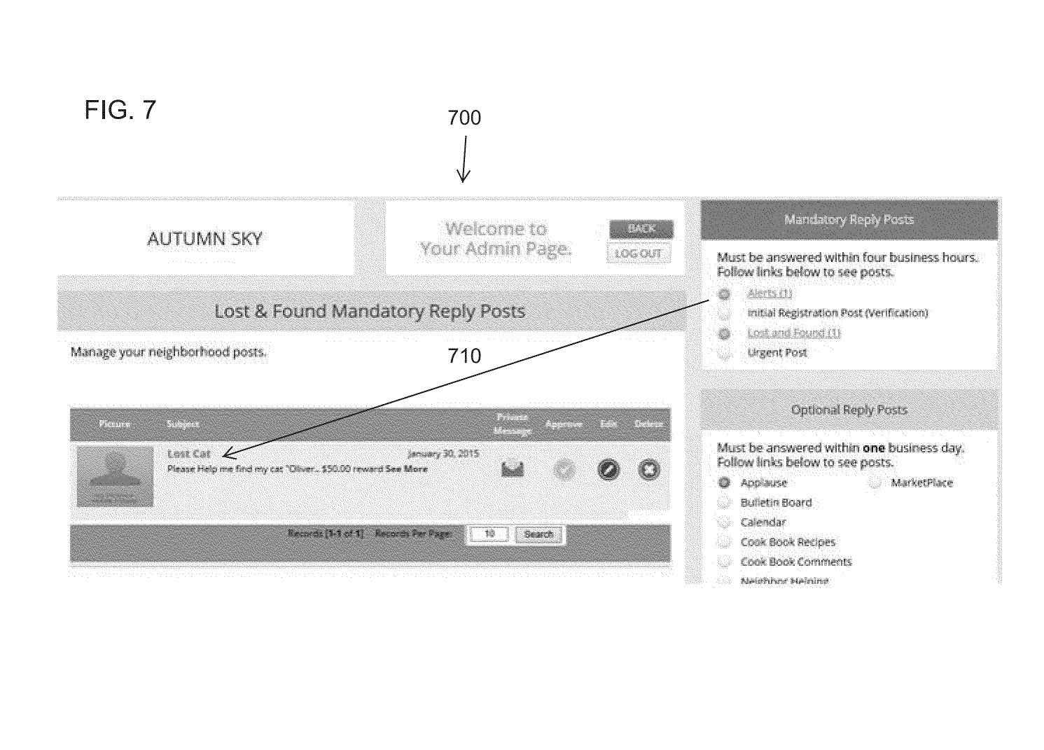

FIG. 7 depicts a pseudo screen shot of a system alert to a NS regarding a mandatory reply post. An alert is mapped 710 with an arrow to the relevant posting.

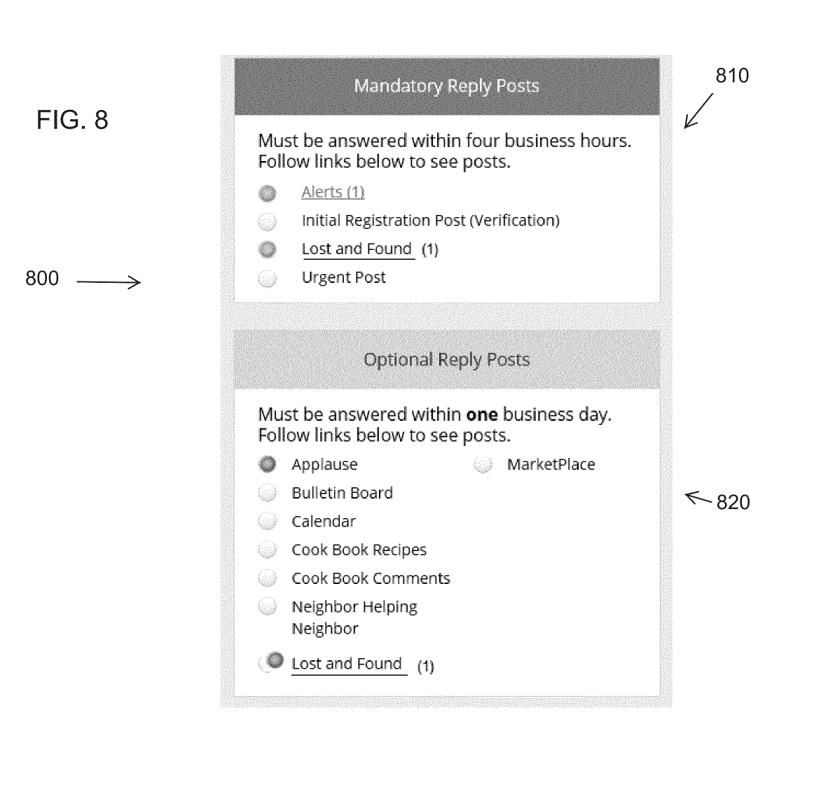

FIG. 8 depicts a pseudo screen shot 800 of both mandatory reply posts and optional reply posts. A mandatory reply post 810 may require a NS to respond is a relatively shorter time period, such as four business hours while an optional reply post 820 may require a NS to responds in a relatively longer time period, such as one business day. An optional reply post may be managed by use of an auto response setting.

Further embodiments and implementations may be described as follows:

The overall system is sometime referred to as Network Neighborhood™ within NeighborhoodLane™ and may be configured to provide a plethora of unique and proprietary Marketing Opportunities and Participant Verification Systems. This process is driven by custom post(s) that a registered neighborhood resident writes up and submits (i.e., post). These posts are marketing opportunities that will allow a Neighborhood Specialist to build and maintain unique and privileged relationships with each and every resident within a designated and specified neighborhood. The Neighborhood Specialist will be the caretaker of all correspondence and act as the neighborhood moderator or communication controller. The uniqueness and unobvious nature of the disclosed embodiments of this process is supported by the condition that these post(s) are marketing opportunities that are available only to a specific and designated Neighborhood Specialist who will respond to these post(s) in order to develop unique and privileged marketing relationships.

### FURTHER DEFINITIONS

Neighborhood Specialist: An individual or entity that has purchased the right to be represented and act as the “Neighborhood Specialist” in a designated and specified neighborhood. In one disclosed embodiment, such a right is leased for an annual fee.

A Neighborhood Specialist is not an employee of the owners of the system; rather he or she is a paying customer of the system owners and utilizes the Network Neighborhood™ tool to create revenue for their specific business. They do this by building long lasting and meaningful relationships with residents in their designated and specified neighborhood. A Neighborhood Specialist is responsible for the implementation of NeighborhoodLane™ which also includes maximizing the neighborhoods social network and internal communications and to verify individuals requesting access actual reside in the neighborhood. This verification is for the safety and security of the residents within the designated and specified neighborhood. An example of an ideal Neighborhood Specialist™ would be a licensed real estate agent as such individuals are well adapted to developing relationships within a specified neighborhood and can easily verify residents who reside in the neighborhood. A Neighborhood Specialist can be any individual that would directly benefit from having strong, sound and respected relationships with the residents of the local neighborhoods where they do business.

Resident(s): The individual or individuals who live in a designated and specified neighborhood. A resident may include a proposed participant or a verified participant.

### Additionally Disclosed Embodiments

Marketing Opportunity and Participant Verification Systems may take the following embodiments and implementations.

Initialization of the Marketing Response Strategy (MRS) tool; this tool manages and optimizes the Network Neighborhood™ Marketing Opportunity and Participant Verification System and can be found under the Administrative Tool section available to the Neighborhood Specialist. The Marketing Response Strategy is completed during the initial Neighborhood Specialist set up phase and can be modified or customized at any time during product ownership by the Neighborhood Specialist or by NeighborhoodLane to address post(s) as they see fit.

The processes of completing the Marketing Response Strategy requires the Neighborhood Specialist to familiarize to themselves with the Mandatory Reply Post (MRP) and the Optional Reply Post (ORP).

The Mandatory Reply Post comprises post(s) that require a prompt approval or denial and are designated as such in order for the Neighborhood Specialist to receive the full benefits of the Marketing Opportunity and Participant Verification Systems. It is expected that the Neighborhood Specialist actively participate in the daily approval process of the Mandatory Reply Post.

There will be times that a Neighborhood Specialist will not be able to attend to the daily MRP approval process due to vacation time, medical leave or for any other reason. This is addressed by the Neighborhood Specialist “activating” the Neighborhood Concierge product at an additional fee. The Neighborhood Concierge will manage the Neighborhood Specialist's account while they are unable to do so allowing all posts to be addressed. The Neighborhood Concierge services can be turned off upon the Neighborhood Specialist return.

The Neighborhood Concierge product will automatically be activated when MPR non-activity is detected by NeighborhoodLane and charges will be applied to the Neighborhood Specialist.

The Optional Reply Post are post(s) that simply require an approval or denial and can be addressed more efficiently by automation. Optional Reply Post can be set to the Auto Response Mode (Auto On) or Mandatory Reply Mode (Auto Off) by the Neighborhood Specialist depending on their preference. An auto response system may include a dictionary of terms or words to omit prior to posting.

Regardless of the post designation; Mandatory Reply Post (MRP) or the Optional Post (OP) the Neighborhood Specialist will be notified of that post by their chosen method as soon as the post is submitted. The post designations are as follows;

Mandatory Reply Post (MRP)

Urgent Post (Any)

Initial Registration Post (Verification)

Neighborhood Specialist Direct Question

Lost and Found (Animals)

Neighborhood Alerts

Optional Reply Post (ORP)

Recipes

Business Directory

Personal Directory

General

Neighborhood News

Classified

Lost and Found (Item)

Calendar

The process of the actual post(s) is as follows:

When a registered resident of a neighborhood submits any information to their NeighborhoodLane site they may do so via a “POST” button either through the website itself or by mobile app. The post can be marked “Urgent Post” or simply marked “Post” as shown in FIG. 5.

The Neighborhood Specialist will then be notified that a post(s) request has been received. The Neighborhood Specialist can choose to be alerted by any one or all of the following methods; by an e-mail to their e-mail address, as a message text to their mobile device, as a mobile app alert and as alerts posted in the Administrative Tools—Network Neighborhood—Marketing Response Strategy (MRS).

“Urgent Post” may be required to be answered within two (2) business hours. Standard post may be required to be responded to within one (1) business day.

The post(s) sit in a queue where the Mandatory Reply Post (MRP) will be reviewed and either approved or rejected by the Neighborhood Specialist exclusively. The Optional Post (OP) will be answered as the Neighborhood Specialist sees fit.

Items.

Disclosed embodiments include the following items:

A machine implemented system of establishing a neighborhood specialist, a plurality of verified participants, with the verified participants residing within a predefined geographic area and the neighborhood specialist controlling messages generated by the verified participants, the system comprising:

a) a plurality of databases, a processor, non-volatile memory, machine readable media and machine readable instructions upon the machine readable media and a server;

b) a neighborhood specialist intake system comprising a neighborhood specialist intake database containing a plurality of predefined geographic areas, the database further containing functions to query the database for geographic areas requested by a potential neighborhood specialist;

c) the neighborhood specialist intake database containing functions to assign an available predefined geographic area to a potential neighborhood specialist;

d) a network neighborhood database comprising a plurality of communication settings, the communication settings controlling messages between a Neighborhood Specialist™ and the plurality of verified participants;

e) a participant database comprising functions to assign unique registration codes mapped to addresses within a predefined geographic area;

f) the participant database comprising functions to accept entries from potential participants, the entries comprising a purported address, a purported name and registration code, the functions enabled to map a purported address to an address previously mapped to the registration code; the system notifying the neighborhood specialist if the codes do not match, if the codes do match, the system accepting the potential participant as a verified participant; and

g) a communication database accepting messages from verified participants and sending the messages to the neighborhood specialist, wherein system parameters require the neighborhood specialist to respond to the messages within a predetermined amount of time.

2. The system of 1 wherein messages from verified participants are reviewed by the neighborhood specialist prior to posting to the plurality of verified participants.

3. The system of 2 wherein messages from verified participants are system labeled as either mandatory replies or optional replies, with the mandatory reply messages requiring shorter amount of time for a neighborhood specialist response as compared to an optional reply.

What is claimed is:

1. A machine implemented system of establishing a neighborhood specialist, a plurality of verified participants, with the verified participants residing within a predefined geographic area and the neighborhood specialist controlling messages generated by the verified participants, the system comprising:
a) a plurality of databases, a processor, non-volatile memory, machine readable media and machine readable instructions upon the machine readable media and a server;
b) a neighborhood specialist intake system comprising a neighborhood specialist intake database containing a plurality of predefined geographic areas, the database further containing functions to query the database for geographic areas requested by a potential neighborhood specialist;
c) the neighborhood specialist intake database containing functions to assign an available predefined geographic area to a potential neighborhood specialist;
d) a network neighborhood database comprising a plurality of communication settings, the communication settings controlling messages between a neighborhood specialist and the plurality of verified participants;
e) a participant database comprising functions to assign unique registration codes mapped to addresses within a predefined geographic area;
f) the participant database comprising functions to accept entries from potential participants, the entries comprising a purported address, a purported name and registration code, the functions enabled to map a purported address to an address previously mapped to the registration code; the system notifying the neighborhood specialist if the codes do not match, if the codes do match, the system accepting the potential participant as a verified participant; and
g) a communication database accepting messages from verified participants and sending the messages to the neighborhood specialist, wherein system parameters require the neighborhood specialist to respond to the messages within a predetermined amount of time.

2. The system of claim 1 wherein messages from verified participants are reviewed by the neighborhood specialist prior to posting to the plurality of verified participants.

3. The system of claim 2 wherein messages from verified participants are system labeled as either mandatory replies or optional replies, with the mandatory reply messages requiring shorter amount of time for a neighborhood specialist response as compared to an optional reply.
